(19) United States
(12) Patent Application Publication
(10) Pub. No.: US 2005/0148718 A1
(43) Pub. Date: Jul. 7, 2005

(54) Rubber composition for inner liner and tire

(76) Inventors: Kouji Ishida, Tokyo (JP); Kumi Fujiki, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/511,326

(22) PCT Filed: Apr. 17, 2003
(86) PCT No.: PCT/JP03/04904

(30) Foreign Application Priority Data
Apr. 18, 2002 (JP) 2002-115732

(51) Int. Cl. C08K 3/34

(52) U.S. Cl. 524/445; 524/449; 524/571; 524/575.5

(57) ABSTRACT

A rubber composition for inner liners which comprises at least one rubber selected from diene-based synthetic rubbers and natural rubber having a glass transition temperature of −55° C. or lower and an organized lamellar clay mineral, an inner liner comprising the rubber composition and a tire in which the rubber composition is used as the inner liner are provided. The rubber composition for inner liners exhibits improved durability at low temperatures in combination with excellent resistance to permeation of the air, and the tire has the inner liner exhibiting this advantageous property.

### TECHNICAL FIELD

The present invention relates to a rubber composition for inner liners and a tire. More particularly, the present invention relates to a rubber composition for inner liners exhibiting excellent resistance to permeation of the air and improved durability at low temperatures and a tire in which the rubber composition is used as the inner liner.

### BACKGROUND ART

Heretofore, an inner liner layer composed of a rubber having small permeability of gases such as a halogenated butyl rubber is disposed on the inner face of a pneumatic tire so that leakage of the air is prevented and the air pressure at the inside of the tire is kept constant. However, when the content of the butyl rubber is increased, strength of the unvulcanized rubber decreases, and problems arise in that fracture of the rubber and formation of holes in sheets tend to take place. In particular, the cord at the inner face tends to be exposed during production of the tire when the thickness of the inner liner is decreased.

It has been known that, when a great amount of carbon black or an inorganic filler having a great aspect ratio is mixed into a rubber composition containing butyl rubber such as a halogenated butyl rubber, durability at low temperatures deteriorates due to an increase in the hardness at low temperatures and workability in the mixing and rolling steps markedly deteriorates.

As the method for decreasing the thickness of the inner liner layer for the purpose of decreasing the weight of an automobile tire in response to the recent social requirement for energy saving, a method in which, for example, a plastic film or a film of a composition composed of a thermoplastic resin and an elastomer is used, is known. However, this method has drawbacks in that resistance to cracks and resistance to flex fatigue in the use at temperatures lower than 5° C. are inferior to those of a layer of a conventional composition containing butyl rubber although the decrease in the weight of the tire can be achieved to some extent, and that the process for producing the tire is complicated.

In Japanese Patent Application Laid-Open No. 2000-80207, a rubber composition in which an organized lamellar clay mineral is dispersed for the purpose of improving the gas barrier property of a rubber is described. However, no descriptions can be found on the application to the inner liner.

In any case, it has been difficult that a rubber composition for inner liners satisfying both of the requirements for resistance to permeation of gases and durability at low temperatures is produced in accordance with a conventional method.

### DISCLOSURE OF THE INVENTION

Under the above circumstances, the present invention has an object of providing a rubber composition for inner liners which is used for an inner liner of a tire and exhibits, in particular, improved durability at low temperatures in combination with excellent resistance to permeation of the air and a tire in which the above rubber composition is used as the inner liner.

As the result of intensive studies by the present inventors to achieve the above object, it was found that the object could be achieved by mixing a organized lamellar clay mineral with a specific rubber component. The present invention has been completed based on this knowledge.

The present invention provides:
1. A rubber composition for inner liners which comprises at least one rubber selected from diene-based synthetic rubbers and natural rubber having a glass transition temperature of −55° C. or lower and an organized lamellar clay mineral;
2. A rubber composition for inner liners described in 1, wherein the diene-based synthetic rubber is styrene-butadiene copolymer rubber;
3. A rubber composition for inner liners described in any one of 1 and 2, wherein the lamellar clay mineral is swelling mica;
4. A rubber composition for inner liners described in any one of 1 to 3, wherein the organized lamellar clay mineral is a lamellar clay mineral organized with a dimethyldialkylammonium ion in which the alkyl group has 15 to 20 carbon atoms; and
5. A rubber composition for inner liners described in any one of 1 to 4, wherein the rubber composition has a brittle point at a low temperature of −40° C. or lower.

The present invention also provides an inner liner comprising a rubber composition described in any one of 1 to 5; and a tire in which a rubber composition described in any one of 1 to 5 is used as an inner liner.

### BRIEF DESCRIPTION OF THE DRAWINGS

FIG. 1 shows a partial sectional view of an example of the pneumatic tire of the present invention, in which 1 means a bead core, 2 means a carcass layer, 3 means an inner liner layer, 4 means a belt portion, 5 means a tread portion, 6 means a side wall portion, and 7 means a bead filler.

### THE MOST PREFERRED EMBODIMENT TO CARRY OUT THE INVENTION

In the rubber composition for inner liners of the present invention, a diene-based synthetic rubber or natural rubber (NR) having a glass transition temperature (Tg) of −55° C. or lower is used as the rubber component. Preferable examples of the diene-based synthetic rubber include styrene-butadiene rubber (SBR), isoprene rubber (IR), butadiene rubber (BR), nitrile rubber (acrylonitrile-butadiene copolymers) (NBR) and hydrogenated nitrile rubber (H-NMR). The diene-based synthetic rubber may be used singly or in combination of two or more. Among these rubbers, styrene-butadiene rubber and nitrile rubber are preferable.

It is necessary that the glass transition temperature of the rubber component in the present invention be −55° C. or lower since, when a rubber having Tg exceeding the above temperature is used, the brittle point of the rubber composition cannot be sufficiently decreased, and the durability at low temperatures as the inner liner cannot be surely exhibited. It is preferable that Tg is −60° C. or lower.

It is preferable that the rubber composition comprises the diene-based synthetic rubber or the natural rubber having a glass transition temperature (Tg) of −55° C. or lower in an amount of 30% by weight or more and more preferably 50% by weight or more based on the amount of the entire rubber component.

In the rubber composition of inner liners of the present invention, an organized lamellar clay mineral is mixed with the above rubber component. The organized lamellar clay mineral means a lamellar clay mineral treated with an organic compound and, in particular, with an organic onium ion. Examples of the lamellar clay mineral include smectite-based clay minerals such as montmorillonite, saponite, hectorite, beidellite, stevensite and nontronite; vermiculite; halloysite; and swelling mica. The lamellar clay mineral may be a natural mineral or a synthetic mineral. The lamellar clay mineral may be used singly or in combination of two or more.

It is preferable that the lamellar clay mineral has the property of being swollen with organic solvents so that molecules of an organic onium salt described below can easily penetrate into the region between layers of (or intercalate) the clay mineral. By using a lamellar clay mineral having the above swelling property, an organic onium salt can sufficiently penetrate into the region between layers of the mineral. The region between the layers of the mineral is further expanded by penetration of rubber molecules during mixing with the rubber, and the nano-order dispersion of the lamellar clay mineral in the rubber matrix can be achieved. From the above standpoint, mica having a great average particle diameter and, in particular, swelling mica is preferable among the above lamellar clay minerals. It is preferable that the average particle diameter of the mica is in the range of 3 to 30 μm.

The organized lamellar clay mineral can be obtained by treating the mineral with an organic onium salt, in particular, an ammonium salt is preferable among the above organic onium salt.

Examples of the organic onium ion used for organizing the lamellar clay mineral in the present invention include hexylammonium ion, octylammonium ion, 2-ethylhexylammonium ion, dodecylammonium ion, octadecylammonium ion, dioctyldimethylammonium ion, trioctylammonium ion, distearyldimethylammonium ion, trimethyloctadecylammonium ion, dimethylotadecylammonium ion, methyloctadecylammonium ion, trimethyldodecylammonium ion, dimethyldodecylammonium ion, methyldodecylammonium ion, trimethylhexadecylammonium ion, dimethylhexadecylammonium ion and methylhexadecylammonium ion.

Unsaturated organic onium ions such as 1-hexenylammonium ion, 1-dodecenylammonium ion, 9-octadecenylammonium ion (oleylammonium ion), 9,12-octadecadienylammonium ion (rinolammonium ion) and 9,12,15-octadecatrienylammonium ion (rinoleylammonium ion) can also be used.

Among the above organized lamellar clay minerals, lamellar clay minerals organized with distrearyldimethylammonium ion are preferable.

The organized lamellar clay mineral can be obtained, for example, by dipping the mineral into an aqueous solution containing the organic onium ion, followed by washing the mineral with water to remove the excess amount of the organic onium ion.

The organized lamellar clay mineral obtained as described above is dispersed in the rubber in the form of nano-order fine particles when the clay mineral is added to and mixed with the rubber component, and very effective improvement in the resistance to permeation of the air is made possible.

Due to the above effect, the rubber composition satisfying both of the requirements for resistance to permeation of the air and durability at low temperatures can be obtained by mixing the above organized lamellar clay mineral, in particular, with the rubber component having a glass transition temperature of −55° C. or lower.

The rubber composition for inner liners of the present invention can comprise the lamellar clay mineral in an amount of 5 to 80 parts by weight per 100 parts by weight of the rubber component. When the amount is less than 5 parts by weight, there is the possibility that the effect of mixing the lamellar clay mineral is not sufficiently exhibited. When the amount exceeds 80 parts by weight, the hardness increases, and this occasionally causes a decrease in resistance to cracks at low temperatures. From this standpoint, it is preferable that the amount of the lamellar clay mineral is in the range of 10 to 60 parts by weight and more preferably in the range of 30 to 50 parts by weight.

The rubber composition of the present invention may further comprise other chemicals conventionally used in the rubber industry which are, for example, fillers such as carbon black, oils, vulcanizing agents, vulcanization accelerators, antioxidants, scorch inhibitors, zinc oxide and stearic acid, in addition to the above compounding components as long as the object of the present invention is not adversely affected.

The brittle point of the rubber composition of the present invention at low temperatures is −40° C. or lower and preferably −42° C. or lower.

The rubber composition of the present invention obtained as described above is used as the rubber composition for inner liners of tires. The above rubber composition is extruded and processed as the material for the inner liner, and the tire of the present invention can be produced in accordance with the conventional process.

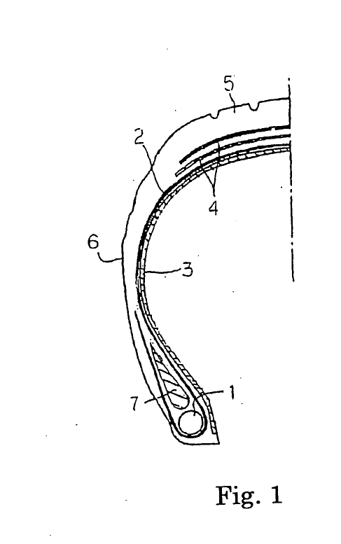

FIG. 1 shows a partial sectional view of an example of the tire of the present invention. The tire comprises a carcass layer 2 which comprises a carcass ply wound around a bead core 1 and disposed in a manner such that the cord direction is laid in the radial direction, an inner liner layer 3 which is disposed on the carcass layer at the inside in the radial direction of the tire, a belt portion comprising a belt layer 4 having two belts disposed on the crown portion of the carcass layer at the outside in the radial direction of the tire, a tread portion 5 disposed on the upper side of the belt portion and side wall portions 6 disposed at both sides of the tread portion.

In the tire having the above construction, the rubber composition of the present invention is applied to the inner liner layer 3 described above.

In the tire of the present invention, an inert gas such as the air and nitrogen gas can be used as the inflating gas.

### EXAMPLES

The present invention will be described more specifically with reference to examples in the following. However, the present invention is not limited to the examples.

The evaluations of various physical properties were conducted in accordance with the following methods.

(1) Glass Transition Temperature (Tg)

Using a differential scanning calorimeter (DSC) “RDC220”, manufactured by SEIKO Co. Ltd., the measurement was conducted under the condition of a temperature elevation of 15° C./minute after cooling at −150° C. A tangent was drawn to the base lines before and after the jump of the DSC curve. The temperature on the DSC curve was read at the point corresponding to the middle of the two contact points and used as Tg.

(2) Permeability of the Air (Resistance to Permeation of the Air)

The permeability of the air was measured at 60° C. with a sample of each vulcanized rubber composition using an air permeation tester M-C1 (manufactured by TOYO SEIKI Co., Ltd.). The permeabilities of the air obtained in Example 1 and Comparative Examples 2 and 3 were expressed as indices using the result of Comparative Example 1 as the reference, which was set at 100. The smaller the index, the better the resistance to permeation of the air.

(3) Brittleness at Low Temperatures

A test piece of each vulcanized rubber sample was prepared, and the test of impact brittleness was conducted in accordance with the test method of impact brittleness at low temperatures described in Japanese Industrial Standard K6301-1995.

### Examples 1 to 3 and Comparative Examples 1 to 3

Components (excluding sulfur) in the formulation shown in Table 1 were mixed at 110° C. for 3 minutes and 45 seconds by a Brabender manufactured by TOYO SEIKI SEISAKUSHO Co., Ltd., and a mixture was obtained. After sulfur was added to the obtained mixture, the resultant mixture was mixed at 80° C. for 1 minute and 30 seconds, and a rubber composition was obtained. The obtained rubber composition was vulcanized at 160° C. using a mold of 0.4 mm for preparation of a sample for the test of the permeability of the air and using a mold of 2 mm for preparation of a sample for measurement of the S—S curve. The results of the evaluations are shown in Table 1.

TABLE 1

| | Comparative | | | | | |
|---|---|---|---|---|---|---|
| | Example | | | Example | | |
| | 1 | 2 | 3 | 1 | 2 | 3 |
| Formulation (part by weight) | | | | | | |
| Br⁻IIR*¹ | 80 | 80 | — | — | — | — |
| NR*² | 20 | 20 | — | — | — | — |
| SBR*³ | — | — | 100 | 100 | 100 | 100 |
| Carbon black^{*4} | 60 | 30 | 70 | 30 | 30 | 30 |
| Oil*⁵ | 10 | 10 | — | — | — | — |
| Stearic acid*⁶ | 2.0 | 2.0 | 2.0 | 2.0 | 2.0 | 2.0 |
| Tackifier*⁷ | 2.0 | 2.0 | — | — | — | — |
| Magnesium oxide*⁸ | 0.3 | 0.3 | — | — | — | — |
| Organized mica (MAE-2)*⁹ | — | — | — | 40 | — | — |
| Organized mica (MAE-5)*¹⁰ | — | 40 | — | — | 40 | — |
| Organized mica (MAE-15)*¹¹ | — | — | — | — | — | 40 |
| Zinc oxide*¹² | 3.0 | 3.0 | 2.0 | 2.0 | 2.0 | 2.0 |
| Antioxidant*¹³ | — | — | 1.0 | 1.0 | 1.0 | 1.0 |
| Vulcanization accelerator | 1.3 | 1.3 | 0.4 | 0.4 | 0.4 | 0.4 |
| A*¹⁴ | | | | | | |
| Vulcanization accelerator | — | — | 0.3 | 0.3 | 0.3 | 0.3 |
| B*¹⁵ | | | | | | |
| Vulcanization accelerator | — | — | 0.8 | 0.8 | 0.8 | 0.8 |
| C*¹⁶ | | | | | | |
| Sulfur*¹⁷ | 0.5 | 0.5 | 1.3 | 1.3 | 1.3 | 1.3 |
| Permeability of the air | 100 | 60 | 270 | 112 | 87 | 80 |
| (60° C.) (index) | | | | | | |
| Brittle point at low | −45 | −32 | −52 | −46 | −45.8 | −44.5 |
| temperature (° C.) | | | | | | |

*¹Br⁻IIR: “EXXON BROMOBUTYL 2255”; manufactured by EXXON CHEMICAL Company; the glass transition temperature: −62° C.
*²NR: Natural rubber; the glass transition temperature: −62° C.
*³SBR: “TUFDENE 2000R”; manufactured by ASAHI KASEI Co., Ltd.; the glass transition temperature: −65° C.
*⁴Carbon black: “NPG”; manufactured by ASAHI CARBON Co., Ltd.
*⁵Oil: “DIANA PROCESS OIL NS-28”; manufactured by IDEMITSU KOSAN Co., Ltd.
*⁶Stearic acid: “PALMAC 1600”; manufactured by ACID CHEM Company.
*⁷Tackifier: “ESCOREZ 8180”; manufactured by EXXON CHEMICAL Company.
*⁸Magnesium oxide: manufactured by KAMISHIMA KAGAKU KOGYO Co., Ltd.
*⁹Organized mica (MAE-2): manufactured by CORP CHEMICAL Co. Ltd.; the average particle diameter: 2 μm.
*¹⁰Organized mica (MAE-5): manufactured by CORP CHEMICAL Co. Ltd.; the average particle diameter: 5 μm.
*¹¹Organized mica (MAE-15): manufactured by CORP CHEMICAL Co. Ltd.; the average particle diameter: 15 μm.
*¹²Zinc oxide: “205P”; manufactured by MIDWEST ZINC Company.
*¹³Antioxidant: “VULKANOX 4020/LG”; manufactured by BAYER Company; N-phenyl-N′-1,3-dimethylbutyl-p-phenylenediamine.
*¹⁴Vulcanization accelerator A: “VULCACIT DM/MG”; manufactured by BAYER Company; dibenzothiazyl disulfide.
*¹⁵Vulcanization accelerator B: “VULCACIT D/EGC”; manufactured by BAYER Company; diphenylguanidine.
*¹⁶Vulcanization accelerator C: “CURE-RITE BBTS”; manufactured by BAYER Company.
*¹⁷Sulfur: sulfur powder; manufactured by TSURUMI KAGAKU KOGYO Co., Ltd.

When the results in Examples 1 to 3 are compared with the results in Comparative Example 1 in which a conventional rubber containing butyl rubber as the main component was used, it is shown that approximately the same performance as those in Comparative Example 1 could be obtained in Examples 1 to 3 with respect to the resistance to permeation of the air and the resistance to brittleness at low temperature. The effect of the present invention was remarkably exhibited in Examples 2 and 3. In Comparative Example 2 in which organized mica was mixed with a rubber containing butyl rubber as the main component, the brittle point at low temperatures was elevated although the resistance to permeation of the air was improved, and the object of the present invention was not satisfied.

As described above, it was confirmed in the present invention that, when the inner liner comprising the specific diene-based rubber is used, mixing, in particular, swelling mica with the rubber is effective for surely obtaining the desired property of retaining the air and the durability at low temperatures.

Industrial Applicability

In the present invention, the rubber composition for inner liners exhibiting excellent resistance to permeation of the air and a low brittle point at low temperatures can be easily obtained by mixing an organized lamellar clay mineral and, in particular, mica having the property of being swollen with organic solvents with the diene-based synthetic rubber having a glass transition temperature of −55° C. or lower. The tire in which this rubber composition is applied to the inner liner exhibited the excellent property of retaining the inflating gas and the remarkably improved durability in the use at very low temperatures such as in very cold areas.

1. A rubber composition for inner liners which comprises at least one rubber selected from diene-based synthetic rubbers and natural rubber having a glass transition temperature of −55° C. or lower and an organized lamellar clay mineral.

2. A rubber composition for inner liners according to claim 1, wherein the diene-based synthetic rubber is styrene-butadiene copolymer rubber.

3. A rubber composition for inner liners according to claim 1, wherein the lamellar clay mineral is swelling mica.

4. A rubber composition for inner liners according to claim 1, wherein the organized lamellar clay mineral is a lamellar clay mineral organized with a dimethyldialkylammonium ion in which the alkyl group has 15 to 20 carbon atoms.

5. A rubber composition for inner liners according to claim 1, wherein the rubber composition has a brittle point at a low temperature of −40° C. or lower.

6. An inner liner comprising a rubber composition described claim 1.

7. A tire in which the rubber composition described in claim 6 is used as an inner liner.

8. A rubber composition for inner liners according to claim 2, wherein the lamellar clay mineral is swelling mica.
